(19) United States
(12) Patent Application Publication
(10) Pub. No.: US 2012/0010907 A1
(43) Pub. Date: Jan. 12, 2012

(54) SYSTEM, METHOD, AND COMPUTER PROGRAM PRODUCT FOR DETERMINING WORKERS COMPENSATION CLAIMS

(75) Inventors: Jonathan Doelling, Jersey City, NJ (US); Matthew Francis, Tampa, FL (US); Timothy Jacobi, New Albany, IN (US)

(73) Assignee: American International Group, Inc., New York, NY (US)

(21) Appl. No.: 13/051,814

(22) Filed: Mar. 18, 2011

Related U.S. Application Data
(60) Provisional application No. 61/315,314, filed on Mar. 18, 2010.

(51) Int. Cl. G06Q 40/00

(52) U.S. Cl. 705/4

(57) ABSTRACT

An Average Weekly Wage calculator application is provided to implement rules-based technology to assist with the adjudication of Workers' Compensation (WC) claims. The AWW calculator application can be included as part of various embodiments of a method for processing a workers' compensation claim, a system for processing a workers' compensation claim, and a non-transitory, tangible computer-readable storage medium bearing instructions for processing a workers' compensation claim. The AWW calculator can be tailored to include jurisdictionally-specific logic to define the required Payment Periods and calculate the Average Weekly Wage in a particular jurisdiction.

### CROSS-REFERENCE TO RELATED APPLICATIONS

This patent application claims the benefit of priority to U.S. Provisional Patent Application No. 61/315,314, filed on Mar. 18, 2010, and entitled, “System, Method, and Computer Program Product for Determining Workers Compensation Claims,” which is incorporated in its entirety herein by this reference.

### TECHNICAL FIELD

The disclosure relates to a system, method, and computer product for determining workers' compensation claims. More particularly, the disclosure relates to a system, method, and computer product for determining workers' compensation claims using an average weekly wage calculator application.

### BACKGROUND

When a worker is injured or becomes ill in the course of performing his job, he is often entitled to workers' compensation benefits. These benefits can include income benefits (other than impairment income benefits), which replace a portion of any lost wages because of a work-related injury or illness; medical benefits, which pay for necessary medical care to treat the work-related injury or illness; burial benefits, which pay for some or all of the deceased employee's funeral expenses to the person who paid the funeral expenses; and death benefits, which replace a portion of lost family income for eligible family members of an employee killed on the job.

Typically, income and death benefit payments are based on an average weekly wage (AWW) of the worker entitled to workers' compensation benefits. The way in which the AWW is calculated can be governed by state law. In Texas for example, Sections 408.041-408.047 of the Texas Workers Compensation Act govern the calculation of the AWW. See Tex. Lab. Code Ann. §§408.041-408.047. Except for cases in which only medical compensation is paid (often referred to as “medical only” claims), it is necessary to determine the average weekly wage (AWW) in virtually every workers' compensation case.

A conventional process to calculate an Average Weekly Wage (AWW) when processing a workers' compensation claim is as follows:
1. The adjuster receives the claim and manually defines the required Payment Periods.
2. The adjuster requests the required wage statement from the employer.
3. After receiving the wage statement, the adjuster analyzes the wage statement for Payment Period accuracy.
4. The adjuster then manually calculates the Average Weekly Wage based on the provided wage statement.
5. If required, the adjuster requests more information and manually recalculates the Average Weekly Wage.

Due to the manual process and detailed state specific regulations for calculating the Average Weekly Wage, miscalculations can be made that inaccurately represent the Average Weekly Wage, as defined by the jurisdictional requirements. These inaccurate calculations can result in incorrect payments of benefits by an insurance company.

### BRIEF SUMMARY

Embodiments of an average weekly wage calculator application are disclosed that provide improved compliance with local jurisdictional requirements. The average weekly wage calculator can be implemented in a non-transitory, tangible computer program product. The disclosure also describes systems and methods that include the average weekly wage calculator computer program product.

The average weekly wage calculator application includes system logic based on jurisdictional requirements that accurately define the Payment Periods and calculate the Average Weekly Wage of a claimant based on the claim information and state regulatory requirements. The system accurately presents the claim handler with the required Payment Periods and the calculated Average Weekly Wage.

In one embodiment, a computer-implemented system for processing a claimant's workers' compensation claim includes a physical computer-readable medium including an average weekly wage calculating program and a processor adapted to execute the average weekly wage calculating program contained on the physical computer-readable medium. The average weekly wage calculating program includes a calculating module having computer executable instruction adapted to determine the average weekly wage based upon a predetermined formula using the claimant's wage information.

In another embodiment, a method for processing a claimant's workers' compensation claim includes employing a processor to execute computer executable instructions stored on a tangible computer-readable medium. The computer executable instructions perform the steps of: receive pre-defined claim information concerning a workers' compensation claim, defining a set of payment periods required to calculate an average weekly wage based on the received claim information, receiving wage information for the required payment periods, and calculating the average weekly wage based on the received payment period information.

In yet another embodiment, a non-transitory, tangible computer-readable storage medium bearing instructions for calculating an average weekly wage for a claimant is provided. The instructions, when executing on one or more computing devices, perform the step of: receiving pre-defined claim information concerning a workers' compensation claim, defining a set of payment periods required to calculate an average weekly wage based on the received claim information, receiving wage information for the required payment periods, and calculating the average weekly wage based on the received payment period information.

### BRIEF DESCRIPTION OF THE SEVERAL VIEWS OF THE DRAWINGS

FIG. 1 is a flow chart illustrating steps of an embodiment of a method for processing a claimant's workers' compensation claim including calculating an average weekly wage (AWW) for the claimant comprising using a physical computer-readable medium including computer-executable instructions for calculating an average weekly wage for the claimant constructed in accordance with principles of the present disclosure (AWW Calculator application).

FIG. 2 is a schematic diagram of an embodiment of a computer-implemented system having a physical computer-readable medium including computer-executable instructions for processing a claimant's workers' compensation claim including an AWW Calculator application constructed in accordance with principles of the present disclosure.

FIG. 3 is a view of an embodiment of a graphical user interface suitable for use with an AWW Calculator application constructed in accordance with principles of the present disclosure.

FIG. 4 is a flow chart illustrating steps of an embodiment of a method for determining an AWW for a workers' compensation claim using an AWW Calculator application constructed in accordance with principles of the present disclosure.

FIG. 5 is a flow chart illustrating steps of an embodiment of a method for launching an AWW Calculator application constructed in accordance with principles of the present disclosure.

FIG. 6 is a flow chart illustrating steps of an embodiment of a method for inputting claim information into an AWW Calculator application constructed in accordance with principles of the present disclosure to determine the required payment periods for computing the AWW.

FIG. 7 is a flow chart illustrating steps of an embodiment of a method for inputting wage information into an AWW Calculator application constructed in accordance with principles of the present disclosure and calculating the AWW.

FIG. 8 is a flow chart illustrating steps of an embodiment of a method for saving an AWW record using an AWW Calculator application constructed in accordance with principles of the present disclosure.

FIG. 9 is a flow chart illustrating steps of an embodiment of a method for presenting a user with an option to save an AWW record before closing an AWW Calculator application constructed in accordance with principles of the present disclosure.

FIG. 10 is a flow chart illustrating steps of an embodiment of a method for retrieving an AWW record using an AWW Calculator application constructed in accordance with principles of the present disclosure.

### DETAILED DESCRIPTION OF EMBODIMENTS INCLUDING AVERAGE WEEKLY WAGE CALCULATOR APPLICATION

Embodiments of an Average Weekly Wage (AWW) Calculator application are provided to implement rules-based technology to assist with the adjudication of Workers' Compensation (WC) claims. The AWW calculator application can be included as part of various embodiments of a method for processing a workers' compensation claim, a system for processing a workers' compensation claim, and a non-transitory, tangible computer-readable storage medium bearing instructions for processing a workers' compensation claim.

The AWW calculator can be tailored to include jurisdictionally-specific logic to define the required Payment Periods and calculate the Average Weekly Wage in a particular jurisdiction. The Average Weekly Wage calculator defines the Payment Periods required to calculate the Average Weekly Wage based on state specific regulations. Additionally, the AWW Calculator calculates the Average Weekly Wage based on the Wage Information specific to each state's regulations. The Average Weekly Wage calculator saves a history of each calculation that can be retrieved, reviewed and expanded upon.

Advantageously, the AWW Calculator can:
1. receive pre-defined claim information concerning a workers' compensation claim from an adjustor;
2. automatically define the Payment Periods required to calculate the AWW based on the received claim information;
3. receive wage information for the required Payment Periods from an adjustor based upon a wage statement; and
4. automatically calculate the AWW based on the received payment period information from the wage statement.
   By using the AWW Calculator, the adjuster can readily discover whether any pay period information is missing. If required, the adjuster requests more information, completes the AWW Calculator and automatically recalculates the Average Weekly Wage. Using the AWW Calculator can reduce leakage in accurately calculating the AWW, improve consistency by creating a single module in which the AWW is calculated, and improve compliance in accurately calculating the AWW by using predetermined, vetted logic that conforms with jurisdictionally-specific requirements.

As a result, the claims handling staff of an insurance company is provided with a computer-implemented tool that consistently provides the Average Weekly Wage per state regulatory requirements. The AWW calculator can improve accuracy by reducing date errors, mathematical errors, and inaccurate interpretation of the regulations. The reduction in these errors in turn can reduce inaccurate payments of benefits and improve consistency and jurisdictional compliance.

The AWW calculator application can be included in a global system for handling high frequency/low complexity claims to achieve cost efficiencies and enhance service for both internal and external customers. Incorporating rules-based adjusting can provide a standardized, system-driven approach to adjusting low complexity claims.

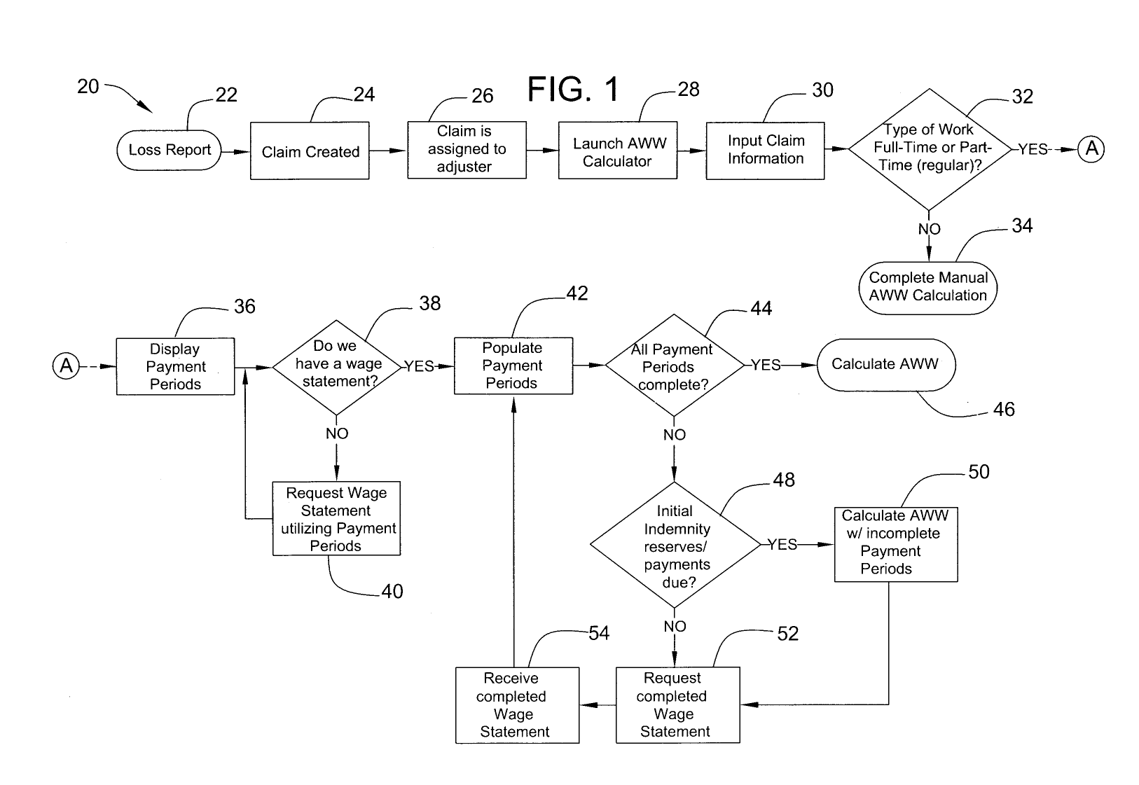

Turning now the Figures, there is shown in FIG. 1 an embodiment of a method 20 for processing a claimant's workers' compensation claim including calculating an average weekly wage for the claimant comprising using a physical computer-readable medium including computer-executable instructions for calculating an average weekly wage for the claimant. A loss report can be made (step 22), and a workers' compensation claim created (step 24). The insurance company can assign an adjuster to the workers' compensation claim (step 26). The adjuster can calculate the AWW for the injured/ill employee who is the subject of the claim using an embodiment of an AWW Calculator application constructed in accordance with principles of the present disclosure.

The method 20 includes steps for the AWW Calculations as follows. The adjuster receives the claim and launches the AWW Calculator application on the computer system (step 28). The adjustor inputs Claim Information according to predetermined categories of information into the AWW Calculator through a graphical user interface (step 30).

At decision step 32, the adjuster inputs the employment status of the worker who submitted the workers' compensation claim to determine whether the employee's employment status is one of those that have been predetermined to be suitable for use with the AWW Calculator, such as full-time employee or regular part-time employee, for example. If the employee's employment status is not among those recognized for use with the AWW Calculator, the AWW calculation can be completed by the adjuster by another means, such as manually, for example (step 34).

The AWW Calculator automatically defines the required Payment Periods based on the Claim Information, and displays the Payment Periods on the graphical user interface (step 36). If it is not already available, the adjuster requests the required wage statement from the employer which includes information customized to the Claim Information (steps 38 and 40). The adjuster populates the Payment Periods in the AWW Calculator based upon information in the wage statement (step 42).

If all payment periods are complete (decision step 44), the AWW Calculator automatically calculates the Average Weekly Wage based on the information entered from the provided wage statement (step 46). If all payment periods are not complete (decision step 44), the adjuster will determine whether initial indemnity reserves/payments are due (decision step 48). If they are, the adjuster will calculate the AWW with incomplete Payment Periods (step 50). If they are not, then the adjuster will request a completed wage statement (step 52). When it is received (step 54), the adjuster will populate the incomplete payment periods (repeat step 42) and calculate the AWW (steps 44 and 46).

The adjuster can conduct further claims processing once the AWW is calculated, for example, by inputting the AWW into an electronic claim services online (eCSO) application adapted to facilitate the claims adjusting process. In some embodiments, the AWW Calculator application can be launched by selecting a link found within the eCSO application.

By using the AWW Calculator, the adjuster can readily be made aware of any missing pay periods. If required, the adjuster can request more information, complete the missing information in the AWW Calculator, and automatically recalculate the AWW. The AWW Calculator can include the capability of saving an electronic record of the Claim Information, Wage Information, and Average Weekly Wage in an electronic database. The adjuster can retrieve and compare historical Average Weekly Wage information from the electronic database by using conventional database querying tools.

In the embodiment of the method shown in FIG. 1, the AWW Calculator is used to determine the AWW of an employee whose employment status is either Full-Time or Part-Time (regular). In other embodiments, additional employment statuses, such as, Part-Time (not regular), Seasonal, Apprentice, Minor, Student, and Trainee, for example, can be included in the AWW Calculator.

The illustrated AWW Calculator includes Primary Workers' Compensation (MJC 014). Other embodiments of the AWW Calculator can include additional Major Class Codes.

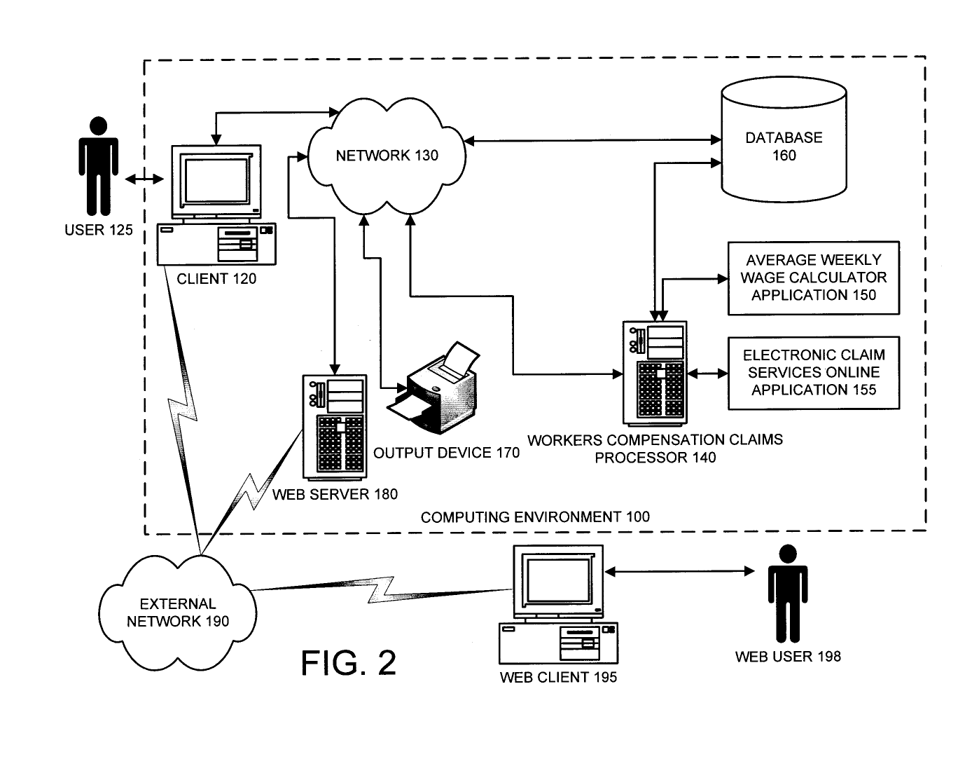

Referring to FIG. 2, an embodiment of a computer-implemented system 100 for automatically calculating the AWW for a workers' compensation claim is shown. A web server 180 can provide access to an internet-based web platform that includes an Average Weekly Wage (AWW) Calculator application 150. The web platform is a centralized, front-end application for entering and sending workers' compensation claim and wage information into a computer-implemented electronic Claim Services Online (eCSO) application 155. The eCSO application 155 can be any suitable computer-implemented application for processing workers' compensation claims, such as those known to one of ordinary skill in the art.

The computing environment 100 can include a number of computer systems, which generally can include any type of computer system based on: a microprocessor, a mainframe computer, a digital signal processor, a portable computing device, a personal organizer, a device controller, or a computational engine within an appliance. More specifically, the computing environment 100 can include a client 120, an internal network 130, at least one workers' compensation claims processor 140 operating the eCSO application 155 and the AWW Calculator application 150, a data storage device 160, an output device 170, and a web server 180 operatively connected to an external network 190. The client 120, the workers' compensation claims processor 140, the data storage device 160, the output device 170, and the web server 180 are operatively connected together via the internal network 130.

A web client 195 can use the computing environment 100 to interface with the provider operating the computing environment 100. For example, an adjustor 198 can use the web client 195 to receive information from, and to transmit information to, the provider's computing environment 100 about the underlying workers' compensation claim. In some embodiments, an employer of the employee who is submitting a workers' compensation claim to the insurance company operating the computing environment 100 can use a web client to transmit information (e.g., wage information) about the workers' compensation claim to the computing environment 100 for use by the AWW Calculator application 150 and to receive updates about the progress of the processing of the workers' compensation claim. In other embodiments, a different communication channel can be established between the adjustor, the claimant, the claimant's employer, etc. and the AWW Calculator application 150 to transmit claim and wage information to the AWW Calculator application 150.

The client 120 can be used to communicate with an authorized user 125, to enter claim and wage data into the data storage device 160 and/or the AWW Calculator application 150, and to execute the AWW Calculator application 150 and the eCSO application 155. The client 120 can comprise at least one input device. The client 120 can generally include any node on a network including computational capability and including a mechanism for communicating across the network 130.

In one embodiment, the client 120 hosts an application front end of the AWW Calculator application 150. The application front end can generally include any component of the AWW Calculator application 150 that can receive input from the user 125 or the client 120, communicate the input to the AWW Calculator application 150, receive output from the AWW Calculator application 150, and present the output to the user 125 or the client 120. In one embodiment, the application front end can be a stand-alone system.

The network 130 can generally include any type of wired or wireless communication channel capable of coupling together computing nodes. Examples of a suitable network 130 include, but are not limited to, a local area network, a wide area network, or a combination of networks.

The workers' compensation claims processor 140 can generally include any computational node including a mechanism for servicing requests from a client for computational resources, data storage resources, or a combination of computational and data storage resources. Furthermore, the workers' compensation claims processor 140 can generally include any system that can host the AWW Calculator application 150. The workers' compensation claims processor 140 can generally include any component of an application that can receive input from the web client 195 via the web server 180 and the client 120, process the input, and present the output to the AWW Calculator application 150, the web server 180, and/or the data storage device 160. The workers' compensation claims processor 140 can generally include any component of an application that can process data, interact with the data storage device 160, and execute business logic for the AWW Calculator application 150.

The AWW Calculator application 150 comprises a computer program product residing on a non-transitory, tangible computer readable medium having a calculating module with a plurality of instructions stored thereon which, when executed by the workers' compensation claims processor 140, cause the processor 140 to perform steps associated with calculating the AWW for a workers' compensation claim. The AWW Calculator application 150 can include a graphical user interface which can facilitate the input of claim and wage information into the AWW Calculator application 150 and the display of the outputs of the AWW Calculator application 150 (e.g., the AWW for a claim) by a user 125, 198 through a client 120, 195.

The architecture solution of the AWW Calculator application 150 is flexible and scalable to include additional jurisdictions, Employment Statuses, and Major Class Codes. The resulting requirements may include diverse inputs, dynamic labels, and additional calculations which can be incorporated into the AWW Calculator by one of ordinary skill in the art. Any suitable computer-readable storage medium can be utilized, including, for example, hard drives, floppy disks, CD-ROM drives, tape drives, zip drives, flash drives, optical storage devices, magnetic storage devices, and the like.

The client 120 can be used by an authorized user 125 to help administer the AWW Calculator application 150. The AWW Calculator application 150 can be designed such that modifications of the jurisdictional variables and logic for calculating the AWW can be modified as desired by an authorized user 125 in order to adjust the logic to comply with jurisdictional-specific requirements, for example.

The database or data storage device 160 can generally include any type of system for storing data in non-volatile storage. This includes, but is not limited to, systems based upon: magnetic, optical, and magneto-optical storage devices, as well as storage devices based on flash memory and/or battery-backed up memory. In one embodiment, the database 160 contains information associated with the various workers' compensation claims processed by the eCSO application 155 and/or the AWW Calculator application 150, including associated claim and wage information and calculated AWWs for the claims. This information can be used by the AWW Calculator application 150 to determine an AWW for a workers' compensation claim being processed. The data storage device 160 can contain a permission database which stores user credentials and permissions specific to each user 125 and web user 198.

The output device 170 can comprise a printer, a display monitor, and a connection to another device, for example. The output device 170 can be used to generate reports which contain information generated by the AWW Calculator application 150. The output device 170 can be used to communicate to the user 125 information about the AWW, which is generated by the AWW Calculator application 150.

A report engine can be provided to generate displays of information stored in the data storage device 160 concerning the workers' compensation claims already processed and under review, which can be viewed using the output device 170, for example. In one embodiment, the report engine further provides pre-configured and/or ad hoc reports relating to the AWW calculated by the AWW Calculator application 150.

The web server 180 can provide a suitable web site or other Internet-based graphical user interface which is accessible by the adjuster 198, for example, to interact with the AWW Calculator application 150. The web client 195 can be connected to the web server 180 through the network connection 190 (e.g., Internet, Intranet, LAN, WAN and the like).

The architecture solution can be designed such that the AWW Calculator application 150 can be accessible by external users. However, the system can be configured in some embodiments such that external users are not authorized to modify Average Weekly Wage data or a selected subset of such data. The web server 180 can use an authentication server in order to validate and assign proper permissions to authorized users of the system. A permission database can store web user credentials and permissions specific to each user, adjuster, employer, etc. The web server 180 can be outfitted with a firewall such that requests originating from outside the computing environment pass through the firewall before being received and processed at the web server 180.

In addition to the components discussed above, the computing environment 100 can further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

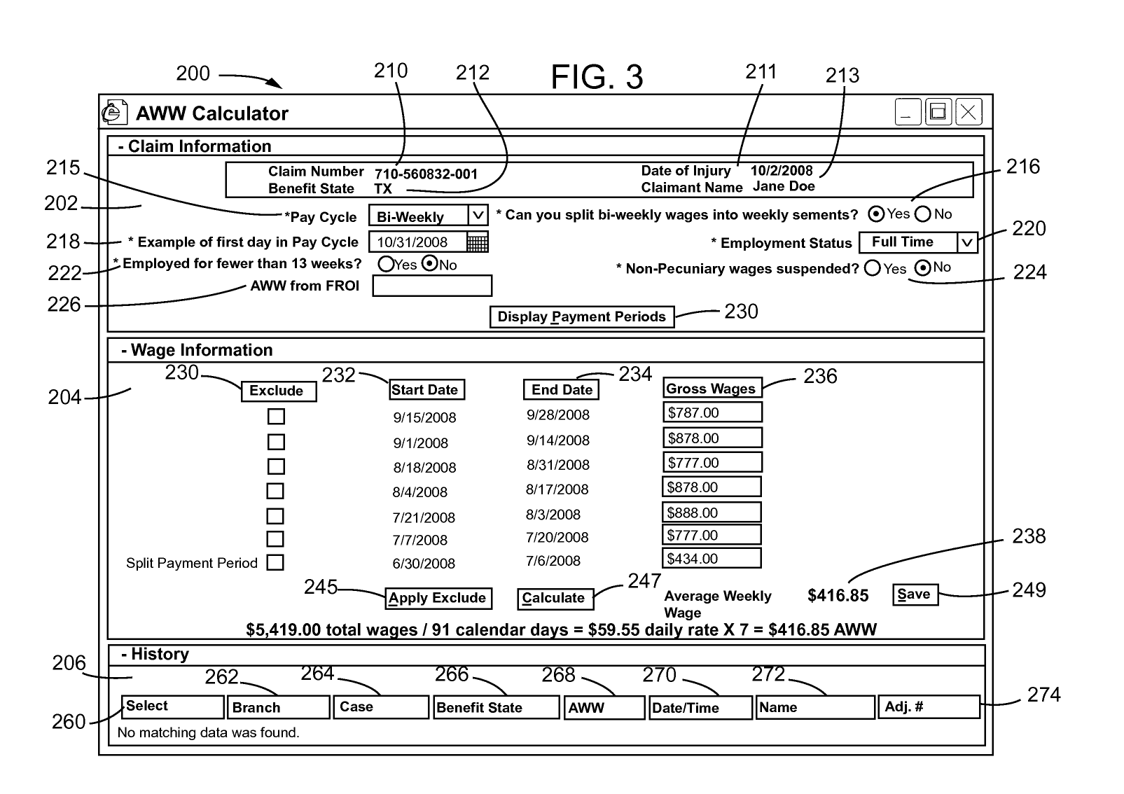

Referring to FIG. 3, an embodiment of a graphical user interface 200 is shown which is suitable for use with an AWW Calculator application constructed in accordance with principles of the present disclosure. The graphical user interface 200 of the AWW Calculator application is split into three collapsible sections: a Claim Information section 202, a Wage Information section 204, and a History section 206. The user enters data in the Claim Information section 202 that will assist in defining the Payment Periods. The user enters wage information in the Wage Information section 204 that will assist in defining the Average Weekly Wage. The user can retrieve previously saved Average Weekly Wage records from the History section 206.

The Claim Information section 202 includes the following data fields: a Claim Number field 210, a Date of Injury field 211, a Benefit State field 212, a Claimant Name field 213, a Pay Cycle field 215, a Can you split bi-weekly wages into weekly segments? field 216, an Example of first day in Pay Cycle? field 218, an Employment Status field 220, an Employed for fewer than 13 weeks? field 222, a Non-pecuniary wages suspended? field 224, and an AWW from FROI field 226. The Claim Information section can also include a [Display Payment Periods] button/link 230.

The Claim Number field 210 can comprise a numerical textbox having a field length of twelve characters in the form 000-000000-000, for example. The Date of Injury field 211 can comprise a date textbox having a field length of eight characters in the form MM/DD/YYYY, for example. The Benefit State field 212 can comprise an alpha textbox having a field length of twenty characters, for example. The Claimant Name field 213 can comprise an alpha textbox having a field length of forty characters for the name of the claimant in the form Last Name, First Name for example.

The Claim Number field 210, the Date of Injury field 211, the Benefit State field 212, and the Claimant Name field 213 can each be pre-populated from the eCSO application when the AWW Calculator application is launched. In some embodiments, the Claim Number field 210, the Date of Injury field 211, the Benefit State field 212, and the Claimant Name field 213 can each be considered a mandatory field that must be completed to enable the functionality of the AWW Calculator application.

The Pay Cycle field 215 can comprise a drop-down list including the following values: Daily, Weekly, Bi-Weekly, Semi-Monthly, and Monthly. In some embodiments, the Pay Cycle field 215 can be considered a mandatory field that must be completed to enable the functionality of the AWW Calculator application.

The Can you split bi-weekly wages into weekly segments? field 216 can comprise a radio button having the values: Yes or No. The Can you split bi-weekly wages into weekly segments? field 216 can be adapted such that it is enabled only if the value of the Pay Cycle field 215 has a value of “Bi-Weekly.” This field 216 can be considered a mandatory field in instances where the value of the Pay Cycle field 215 has a value of “Bi-Weekly.” In some embodiments, the Can you split bi-weekly wages into weekly segments? field 216 is enabled/disabled based on the Benefit State populated in the Claim Information section 202 of the AWW Calculator.

The Example of first day in Pay Cycle? field 218 can comprise a date textbox having a field length of eight characters in the form MM/DD/YYYY, for example. In some embodiments, the Example of first day in Pay Cycle? field 218 can be considered a mandatory field that must be completed to enable the functionality of the AWW Calculator application.

A help message can be associated with the Example of first day in Pay Cycle? field 218 which states, for example, “This date corresponds to the actual first date of a pay cycle not the date the wages were paid. Additionally, a calendar function is required for this field. The user will be able to click on the function to select a date from the calendar.” If a user clicks on the help function, the help message is provided on the data field.

The Employment Status field 220 can comprise a drop-down list including the following values: Full Time, Part Time (regular), Part Time (not regular), Seasonal, Apprentice, Minor, Student, and Trainee. In some embodiments, the Employment Status field 220 can be considered a mandatory field that must be completed to enable the functionality of the AWW Calculator application. The AWW Calculator can be configured such that the only valid values when defining the Payment Periods are: Full-Time and Part-Time (regular). If any other values are selected, the AWW Calculator application can be adapted to present the user with the following Edit Message: “The AWW Calculator does not calculate the Average Weekly Wage of [invalid Employment Status selected] workers'. Please consult the applicable [Benefit State] Statute related to this Employment Status to ensure the AWW is calculated correctly.” In other embodiments, other values for employment status can be valid values for enabling the functionality of the AWW Calculator application.

In other embodiments, the values in the Employment Status field 220 can vary based on the Benefit State populated in the Claim Information section 202 of the AWW Calculator. In yet other embodiments the set of valid employment statuses can vary based on the Benefit State populated in the Claim Information section 202 of the AWW Calculator.

The Employed for fewer than 13 weeks? field 222 can comprise a radio button having the values: Yes or No. In the illustrated embodiment, this label for the field 222 accurately describes the field for the Benefit State of Texas. In other embodiments of the AWW Calculator application, the label of the field 222 may vary based on the selected Benefit State of the employee. In some embodiments, the Employed for fewer than 13 weeks? field 222 can be considered a mandatory field that must be completed to enable the functionality of the AWW Calculator application.

In some embodiments, the Employed for fewer than 13 weeks? field 222 is enabled/disabled based on the Benefit State populated in the Claim Information section 202 of the AWW Calculator. This field 222 subsequently affects the Similar Employee field and the No Similar Employee Found checkbox. Additionally, the label and nature of the field may vary based on the Benefit State populated in the Claim Information section 202 of the AWW Calculator.

The Non-pecuniary wages suspended? field 224 can comprise a radio button having the values: Yes or No. In some embodiments, the Non-pecuniary wages suspended? field 224 can be considered a mandatory field that must be completed to enable the functionality of the AWW Calculator application.

A help message can be associated with the Non-pecuniary wages suspended? field 224 which states, for example, “Non-pecuniary Wages include all wages paid to the employee in a form other than money. These include, but are not limited to: Health Insurance, Laundry/Cleaning, Clothing/Uniforms, Lodging/Housing, Foods/Meals & Vehicle/Fuel but do not include monetary allowances or stipends paid to allow the employee to purchase the benefits.” If a user clicks on the help function, the help message is provided on the data field.

In some embodiments, the Non-pecuniary wages suspended? field 224 is enabled/disabled based on the Benefit State populated in the Claim Information section 202 of the AWW Calculator. Additionally, the label of the field 224 can vary based on the Benefit State populated in the Claim Information section 202 of the AWW Calculator.

The AWW from FROI field 226 can comprise a numerical textbox having a field length of eight characters in the form $0.00, for example. In some embodiments, the AWW from FROI field 226 can be considered an optional field that need not be completed to enable the functionality of the AWW Calculator application.

A help message can be associated with the AWW from FROI field 226 which states, for example, “Refer to box 36 on the DWC 1 and enter the AWW information provided. If an AWW was not provided attempt to manually calculate the AWW combining the information provided in box 36 and box 37. If box 36 and box 37 do not contain sufficient information to estimate the AWW leave the DWC 1 field in the AWW calculator blank.” If a user clicks on the help function, the help message is provided on the data field.

In some embodiments, the AWW from FROI field 226 is enabled/disabled based on the Benefit State populated in the Claim Information section 202 of the AWW Calculator. The AWW from FROI field 226 can subsequently affect the calculation preformed if the first Payment Period in the Wage Information section 204 is not complete. Additionally, the label and nature of the field 226 can vary based on the Benefit State populated in the Claim Information section 202 of the AWW Calculator.

In other embodiments, the text provided in the Help Functions can vary based on the Benefit State populated in the Claim Information section 202 of the AWW Calculator. In yet other embodiments, Help Functions can be provided for additional fields.

In some embodiments, the AWW Calculator application can present a graphical user interface that includes the [Display Payment Periods] button/link 230, as shown in FIG. 3. Once the [Display Payment Periods] button/link 230 is clicked, the AWW Calculator application can define and present the Payment Periods in the Wage Information section 204. The [Display Payment Periods] button/link 230 can be disabled upon initial entry. The [Display Payment Periods] button/link 230 can be configured such that it will not perform its function if a mandatory field is not completed. The [Display Payment Periods] button/link 230 can be enabled when all mandatory data fields are populated. Upon selecting the [Display Payment Periods] button/link 230, the AWW Calculator application can indicate the incomplete mandatory fields if necessary, such as by presenting those fields in a different color. If a user clicks the [Display Payment Periods] button/link 230 and there are existing Payment Periods, the AWW Calculator application can be adapted to clear all existing information and re-display the Payment Periods; In addition to being adapted to be selected by a mouse or cursor, a hotkey (such as, ‘Ctrl+P’) can be provided which will initiate the [Display Payment Periods] function.

In order to determine the Payment Periods, the AWW Calculator application determines the Pay Cycle based on the data entered in the Claim Information section 202. The AWW Calculator application evaluates the Example of first day in Pay Cycle? and Pay Cycle fields 218, 215 to determine the employer's actual Pay Cycle. For Example, if the Example of first day in Pay Cycle? field 218 equals “Sep. 21, 2009” and the Pay Cycle field 215 equals “Bi-Weekly,” the employer's actual Pay Cycle will start on Sep. 21, 2009 and end on Oct. 4, 2009. The AWW Calculator application is adapted to extrapolate this information to define the Payment Periods.

After determining the employer's actual Pay Cycle, the AWW Calculator application is adapted to define the Payment Periods based on the data entered in the Claim Information section 202. The AWW Calculator application can be adapted to define the first Payment Period as the Pay Cycle prior to the Date of Injury that does not include the Date of Injury. In the illustrated embodiment, the State of Texas requires that the employee's wages covering the thirteen previous weeks of employment are acquired in order to accurately calculate the Average Weekly Wage. This value can vary based on the Benefit State, and the AWW Calculator application can be adapted to determine the Payment Periods for different Benefit States according to the controlling requirements of the particular state.

In the illustrated example, the AWW Calculator application is adapted to define all previous Payment Periods until the following requirements are met per Pay Cycle (these requirements can be varied by Benefit State):
If “Daily” is selected for the Pay Cycle field 215, the AWW Calculator application defines the ninety-one previous Payment Periods immediately preceding the Date of Injury.
If “Weekly” is selected for the Pay Cycle field 215, the AWW Calculator application defines the thirteen previous Payment Periods immediately preceding the Date of Injury.
If “Bi-Weekly” is selected for the Pay Cycle field 215, the AWW Calculator application defines the seven previous Payment Periods immediately preceding the Date of Injury. See below for a discussion of the situation where the Can you split bi-weekly wages into weekly segments? field 216 equals “Yes”.
If “Semi-Monthly” is selected for the Pay Cycle field 215, the AWW Calculator application define the six previous Payment Periods immediately preceding the Date of Injury. For example, if the Example of first day in Pay Cycle? field 218 equals “Sep. 21, 2009” and the Pay Cycle field 215 equals “Semi-Monthly” and the Date of Injury field 211 equals “Oct. 1, 2009,” the AWW Calculator application will define the Payment Periods as follows:

| Start Date | End Date |
|---|---|
| Sep. 06, 2009 | Sep. 20, 2009 |
| Aug. 21, 2009 | Sep. 05, 2009 |
| Jul. 06, 2009 | Aug. 20, 2009 |
| Jun. 21, 2009 | Jul. 05, 2009 |
| Jun. 06, 2009 | Jun. 20, 2009 |
| May 21, 2009 | Jun. 05, 2009 |

If “Monthly” is selected for the Pay Cycle field 215, the AWW Calculator application defines the three previous Payment Periods immediately preceding the Date of Injury.

The Can you split bi-weekly wages into weekly segments? field 216 is enabled only if the value for the Pay Cycle field 215 equals “Bi-Weekly.” If the Can you split bi-weekly wages into weekly segments? field 216 equals “Yes,” the AWW Calculator application defines the Payment Periods as follows:
If the Date of Injury occurs in the second week of a bi-weekly Pay Cycle, the AWW Calculator application defines the Payment Period, immediately preceding the Date of Injury, as the first week of the same bi-weekly Pay Cycle. The AWW Calculator application then continues to define the six previous Payment Periods. For example, if the Example of first day in Pay Cycle? field 218 equals “Sep. 21, 2009,” the Pay Cycle field 215 equals “Bi-Weekly,” and the Date of Injury field 211 equals “Oct. 1, 2009,” then the AWW Calculator application defines the Payment Periods as follows:

| Start Date | End Date |
|---|---|
| Sep. 21, 2009 | Sep. 27, 2009 |
| Sep. 07, 2009 | Sep. 20, 2009 |
| Aug. 24, 2009 | Sep. 06, 2009 |
| Aug. 10, 2009 | Aug. 23, 2009 |
| Jul. 27, 2009 | Aug. 09, 2009 |
| Jul. 13, 2009 | Jul. 26, 2009 |
| Jun. 29, 2009 | Jul. 12, 2009 |

If the Date of Injury occurs in the first week of a bi-weekly Pay Cycle, the AWW Calculator application will define the Payment Period, furthest from the Date of Injury, as the second week of the bi-weekly Pay Cycle. The AWW Calculator application defines the six previous Payment Periods immediately preceding the Date of Injury with the Payment Period furthest from the Date of Injury defined as the second week of the bi-weekly Pay Cycle. For example, if the Example of first day in Pay Cycle? field 218 equals “Sep. 21, 2009,” the Pay Cycle field 215 equals “Bi-Weekly,” and the Date of Injury field 211 equals “Sep. 22, 2009, then the AWW Calculator application defines the Payment Periods as follows:

| Start Date | End Date |
|---|---|
| Sep. 07, 2009 | Sep. 20, 2009 |
| Aug. 24, 2009 | Sep. 06, 2009 |
| Aug. 10, 2009 | Aug. 23, 2009 |
| Jul. 27, 2009 | Aug. 09, 2009 |
| Jul. 13, 2009 | Jul. 26, 2009 |
| Jun. 29, 2009 | Jul. 12, 2009 |
| Jun. 22, 2009 | Jun. 28, 2009 |

Additionally, the AWW Calculator application can be adapted to indicate the split Payment Period. (i.e. place the text ‘Split Payment Period’ next to the split Payment Period.)

The Wage Information section 206 includes the following data field for each defined Payment Period: an Exclude field 230, a Start Date field 232, an End Date field 234, and a Gross Wages field 236. In addition, the Wage Information section 204 includes an Average weekly Wage field 238 and is enabled to include a Similar Employee field, a No Similar Employee Found field, and one or more Non-Pecuniary Wages fields under certain conditions.

The Wage Information grid is included in the Wage Information section 206. This grid contains the following columns: Exclude 230, Start Date 232, End Date 234, Gross Wages 236, and Non-Pecuniary Wages (if enabled). The Start Date and End Date fields 232, 234 are automatically populated through the [Display Payment Periods] function 230 of the AWW Calculator application. The Gross Wages and Non-Pecuniary Wages (if enabled) fields 236 are manually populated by the user. Non-Pecuniary Wages will be enabled if the answer to the “Has the employer suspended non-pecuniary wages?” field 224 equals “Yes.”

The Exclude field 230 can comprise a check box located to the left of each Payment Period. In some embodiments, the Exclude field 230 of each Payment Period can each be considered an optional field that need not be completed to enable the functionality of the AWW Calculator application.

A help message option can be associated with the Exclude field 230. This help option can be adapted to be jurisdictionally driven according to the Benefit State's controlling statutes. For the state of Texas, for example, the help message can state, “Check the ‘Exclude’ box if there were any hours lost in a given pay period due to circumstances beyond the control of the Injured Worker (e.g. illness, weather, other). Consult Rule 128.3 (g) of the Texas Administrative Code for further discussion on lost time from work without remuneration. Please contact the appropriate Compliance Reviewer with questions in regard to the exclusion of pay periods.” If a user clicks on the help function, the help message is provided on the data field.

In some embodiments, the Exclude checkbox 230 is enabled/disabled based on the Benefit State populated in the Claim Information section 202 of the AWW Calculator. Additionally, the label of the field 230 can vary based on the Benefit State populated in the Claim Information section 202 of the AWW Calculator.

The Start Date field 232 and the End Date field 234 can each comprise a date textbox having a field length of eight characters in the form MM/DD/YYYY. The values for the Start Date field 232 and the End Date field 234 of each Payment Period can be populated by the AWW Calculator application based upon the calculation performed using its [Display Payment Periods] function 230.

The Gross Wages field 236 can comprise a numerical textbox having a field length of eight characters in the form $0.00, for example. In some embodiments, the Gross Wages field 236 can be considered a mandatory field if the corresponding Non-Pecuniary Wages field has a value that must be completed to enable the functionality of the AWW Calculator application.

The Non-Pecuniary Wages field can comprise a numerical textbox having a field length of eight characters in the form $0.00, for example. The Non-Pecuniary Wages field can be adapted to be enabled if the “Has the employer suspended non-pecuniary wages?” field equals “Yes.” In some embodiments, if the Non-pecuniary wages suspended? field 224 equals “Yes” and the corresponding Gross Wages field 236 has a value, the Non-Pecuniary Wages field can be considered a mandatory field that must be completed to enable the functionality of the AWW Calculator application. In some embodiments, the label of the Non-Pecuniary Wages field can vary based on the Benefit State populated in the Claim Information section 202 of the AWW Calculator.

The Similar Employee field can comprise an alphabetical textbox having a field length of thirty characters, for example. The Similar Employee field can be adapted to be enabled if the Employed for fewer than 13 weeks? field equals “Yes” and disabled if the No Similar Employee Found field is checked. In some embodiments, if the Employed for fewer than 13 weeks? field 222 equals “Yes” and the No Similar Employee Found field is unchecked, the Similar Employee field can be considered a mandatory field that must be completed to enable the functionality of the AWW Calculator application.

The No Similar Employee Found field can comprise a checkbox, for example. The No Similar Employee Found field can be adapted to be enabled if the Employed for fewer than 13 weeks? field 222 equals “Yes” and disabled if the Similar Employee field has a value. In some embodiments, if the Employed for fewer than 13 weeks? field 222 equals “Yes” and the Similar Employee field is blank, the No Similar Employee Found field can be considered a mandatory field that must be completed to enable the functionality of the AWW Calculator application.

The Average Weekly Wage field 238 can comprise a numerical textbox having a field length of eight characters in the form $0.00, for example. The Average Weekly Wage field 238 can be populated by the AWW Calculator application with the calculated AWW for the claim after performing the [Calculate] function.

The Wage Information section 204 can also include an [Apply Exclude] button/link 245, a [Calculate] button/link 247, and a [Save] button/link 249. The [Calculate] function is included in the Wage Information section 204. Once the [Calculate] button/link 247 is clicked, the AWW Calculator application can calculate and present the AWW in the AWW field 238. The [Calculate] button/link 247 can be disabled upon initial entry. The [Calculate] button/link 247 can be enabled if either the AWW from FROI field 226 has a value or at least one Payment Period is complete. The [Calculate] button/link 247 can be adapted such that the AWW Calculator application will not perform the [Calculate] function until all mandatory fields are completed. In addition to being adapted to be selected by a mouse or cursor, a hotkey (such as, ‘Ctrl+C’) can be provided which will initiate the [Calculate] function.

When the user selects the [Calculate] button/link 247, the AWW Calculator application calculates the Average Weekly Wage based on the fields populated in the Wage Information grid. Upon click, the AWW Calculator application can indicate the incomplete mandatory fields if necessary.

In an embodiment, an edit message can be displayed when all mandatory fields have not been completed. The edit message can appear, when the user clicks the [Calculate] link/button 247. The Edit or Error Message can be any suitable form, such as, “Please complete all mandatory fields.” for example. An [OK] button can be provided to close the Message.

If the first required Payment Period is missing, the AWW Calculator application will populate the value entered in the AWW from FROI field 226 in the Claim Information section 202 in the Average Weekly Wage field 238 of the Wage Information section 204. If the AWW from FROI field 226 does not have a value or if the first Payment Period does have a value, the AWW Calculator application will calculate the Average Weekly Wage as follows:
The AWW Calculator application determines the “Total Number of Days” by evaluating which Payment Periods contain a value in the Gross Wage field 236 and counting the individual days in those Payment Periods (a value of zero is considered).
The AWW Calculator application determine the “Total Wages” by adding fields in which the Gross Wages fields 236 and Non-Pecuniary Wages fields have a value (a value of zero is considered).
The AWW Calculator application divides the “Total Wages” by the “Total Number of

Days” (average wage per day) and multiplies by 7 to determine the Average Weekly Wage. “Average Weekly Wage”=(“Total Wages”/“Total Number of Days”)×7.
The AWW Calculator application rounds the Average Weekly Wage value to the nearest cent. Thus, if the Average Weekly Wage calculation is $750.765, the Average Weekly Wage sets to a value of $750.77.

For example, if the Pay Cycle field 215 equals “Monthly” and the Wage Information is populated as follows:

| Start Date | End Date | Gross Wages | Non-Pecuniary Wages |
|---|---|---|---|
| Aug. 21, 2009 | Sep. 20, 2009 | $5,000.00 | $200.00 |
| Jul. 21, 2009 | Aug. 20, 2009 | $4,800.00 | $190.00 |
| Jun. 21, 2009 | Jul. 20, 2009 | | |

The “Total Number of Days” equals sixty-two (total days between and including Jul. 21, 2009 and Sep. 20, 2009), and the “Total Wages” equals $10,190.00 ($5,000.00+$200.00+$4,800.00+$190.00). The Average Weekly Wage is equal to $1150.48 ($1150.48=($10,190.00/62)*7).

The user has the option to exclude unjust Payment Periods due to wage irregularities (e.g. unpaid sick time). If the Exclude checkbox 230 is checked, the corresponding Payment Period will be disabled. The values of an excluded Payment Period are not considered in the AWW calculation. An excluded Payment Period will not be required in order to complete all Payment Periods. The AWW Calculator application can add an additional Payment Period for each excluded Payment Period at the bottom of the Wage Information grid. Following the AWW calculation, the AWW Calculator application indicates the incomplete Payment Periods (e.g. color-codes the rows in which the Payment Periods are incomplete). The [Exclude] function can be initiated by selecting the [Apply Exclude] button/link 245. In addition to being adapted to be selected by a mouse or cursor, a hotkey (such as, ‘Ctrl+A’) can be provided which will initiate the [Exclude] function.

In the illustrated embodiment, the [Save] button/link 249 can be disabled upon initially launching the AWW Calculator application. Once the AWW is calculated, the [Save] function is enabled. The user can save the current AWW record by initiating the [Save] function. Once clicked, the AWW Calculator application can save a record of all inputs and outputs. If the user initiates the [Save] function, the AWW Calculator application saves a record of all inputs and outputs, including the Name and Adjustor Number of the user saving the information. A single AWW record can be saved per launch of the AWW Calculator. If the [Save] function is initiated and has already been initiated in the same session, the AWW Calculator application can be adapted to save over the current AWW record. In addition to being adapted to be selected by a mouse or cursor, a hotkey (such as, ‘Ctrl+S’) can be provided which will initiate the [Save] function. The AWW Calculator application can also subsequently refresh the History Grid to show the saved AWW record.

If a user attempts to close the graphical user interface 200 of the AWW Calculator without saving the current AWW calculation, the AWW Calculator application can be configured to give the user the option of saving before exiting the AWW Calculator. In one embodiment, an edit/error message can be displayed when the user attempts to close the AWW Calculator application. The edit message can appear when the user selects the [Close] link/button 280 and the current calculation has not been saved. The message can be any suitable form, such as, “Would you like to save the current Average Weekly Wage calculation?” for example. [Yes] & [No] buttons can be provided along with the message to allow the user to select the option of saving the record or not saving the record and closing the AWW Calculator application, respectively.

The illustrated History Information section 206 includes the following data fields for each stored AWW record: a Select field 260, a Branch field 262, a Case field 264, a Benefit State field 266, an Average Weekly Wage field 268, a Date/Time field 270, a Name field 272, and an Adjuster Number field. 274 Each AWW record can be stored as a row of a History grid in the History Information section 206. These columns are populated with the information contained from the corresponding historical record attached to the claim number loaded to the AWW Calculator. The History Information section 206 can also include a [Display] button/link which can initiate a [Display] function.

The Select field 260 can comprise a checkbox, for example. The Select field 260 can be adapted such that if it is checked, it will become unchecked upon the selection of another Select field in the History Information grid.

The Branch field 262 can comprise a textbox having a field length of thirty characters, for example. The Branch field 262 is populated with the name of the branch associated with the particular claim that was saved to the AWW record.

The Case field 264 can comprise a numerical textbox having a field length of nine characters in the form 000-000000, for example. The Case field 264 is populated with the claim number that was saved to the AWW record.

The Benefit State field 266 can comprise a textbox having a field length of two characters, for example. The Benefit State field 266 is populated with the two-letter abbreviation of the state of the claim that was saved to the AWW record.

The Average Weekly Wage field 268 can comprise a numerical textbox having a field length of eight characters in the form $0.00, for example. The Average Weekly Wage field 268 of the History Information grid is populated with the AWW that was saved to the AWW record.

The Date/Time field 270 can comprise a date/time textbox in the form MM/DD/YYYY, 00:00:00 (am/pm), for example. The Date/Time field 270 is populated with the date and time that the AWW record was last saved.

The Name field 272 can comprise a textbox having a field length of thirty characters, for example. The Name field 272 is populated with the name (last name, first name) of the adjustor that saved the AWW record.

The Adjuster Number field 274 can comprise a numerical textbox having a field length of four characters, for example. The Adjuster Number field 274 is populated with the adjuster number of the adjuster that saved the AWW record.

The [Display] function can be initially disabled upon launching the AWW Calculator application. The [Display] function can be enabled once one of the Select fields 260 is checked. If a user selects an AWW record from the History grid by checking its associated Select field 260 and clicks the [Display] button/link, the AWW Calculator application operates the [Display] function and populates all Claim Information and Wage Information fields in the Claim Information section 202 and the Wage Information section 204 with the corresponding data in the historical AWW record. In addition to being adapted to be selected by a mouse or cursor, a hotkey (such as, ‘Ctrl+D’) can be provided which will initiate the Display function.

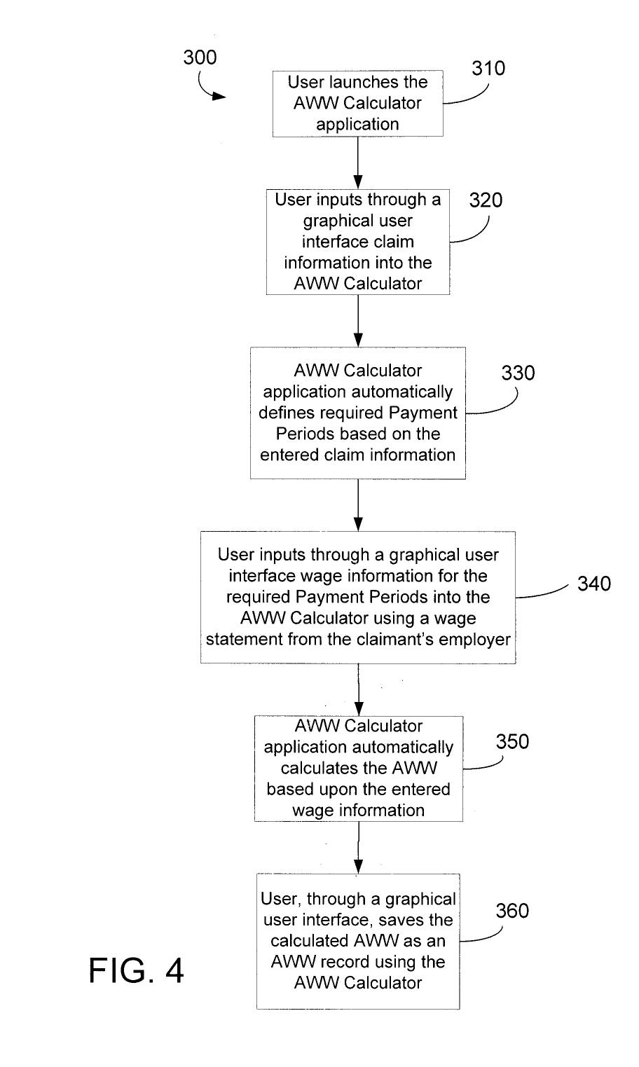

Referring to FIG. 4, an embodiment is shown of a method 300 for determining an AWW for a workers' compensation claim using an AWW Calculator application constructed in accordance with principles of the present disclosure. A user launches the AWW Calculator application (step 310) and inputs claim information into the AWW Calculator application through a graphical user interface (step 320). The AWW Calculator application automatically defines the required Payment Periods based upon the entered claim information (step 330). The user, via the graphical user interface, inputs into the AWW Calculator application wage information for the Payment Periods using a wage statement from the claimant's employer (step 340). The AWW Calculator application automatically calculates the AWW based upon the entered wage information (step 350). The user, via the graphical user interface, can save the calculated AWW as an AWW record in a database using the AWW Calculator application (step 360).

In an embodiment of an AWW Calculator application, a graphical user interface of an eCSO application can include an [AWW Calculator] button/link adapted to launch the AWW Calculator application. Once clicked, the AWW Calculator application will launch the AWW Calculator. The [AWW Calculator] button/link can be disabled upon initial entry. The [AWW Calculator] button/link can be enabled when a claim is loaded to the eCSO WC status bar which is from a Benefit State that is one of the set of Benefit States for which the AWW Calculator application is configured to calculate the AWW. The AWW Calculator application can be a such that additional logic can be added to include additional Benefit States over time. If a user clicks on the [AWW Calculator] button/link in the eCSO application, the AWW Calculator will launch.

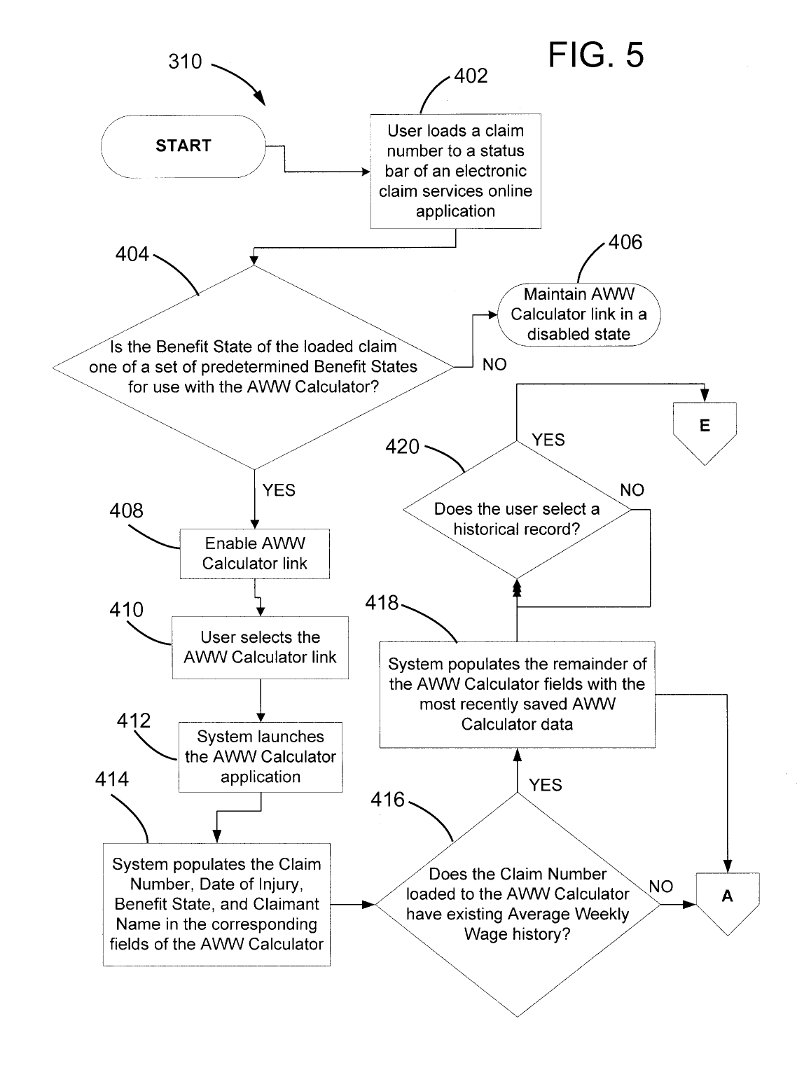

An embodiment of a method 310 of launching an AWW Calculator application is shown in FIG. 5. In the illustrated embodiment, a user has logged into the eCSO application. The user loads a claim number into the eCSO application (step 402) and that claim's Benefit State is one of a set of predetermined Benefit States for use with the AWW Calculator, such as, Texas, for example (decisional step 404). The system enables an [AWW Calculator] button/link in the eCSO application adapted to launch the AWW Calculator application (step 408).

The user clicks the [AWW Calculator] link (step 410), the system launches the AWW Calculator (step 412). The AWW Calculator application populates the Claim Number field, the Date of Injury field, the Benefit State field, the Date of Injury field, and the Claimant Name field in the graphical user interface of the AWW Calculator with the related values corresponding to the Claim Number entered in the eCSO application (step 414).

If the Claim Number loaded to the AWW Calculator has existing Average Weekly Wage history (decisional step 416), the AWW Calculator application populates the remainder of the AWW Calculator fields with the most recently saved AWW Calculator data (step 418). In some embodiments, the AWW Calculator application can be configured such that if the Benefit State of a claim were to change, the AWW Calculator application would not populate the most recently-saved record.

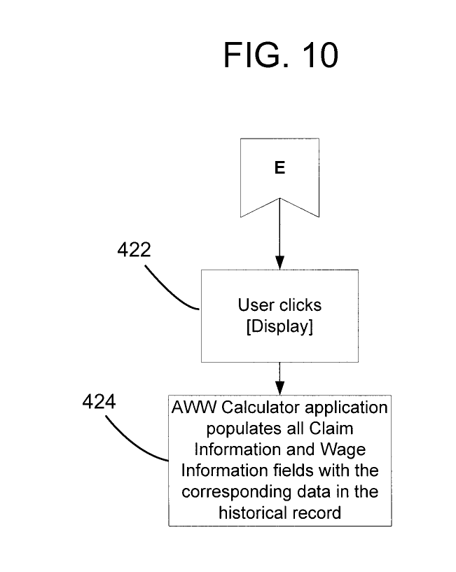

If the user selects a historical AWW record from the History Information section of the graphical user interface (decisional step 420) and clicks the [Display] function (step 422), the AWW Calculator application populates the Claim Information and Wage Information fields with the corresponding date in the historical AWW record (decisional step 424) (see FIG. 10 also).

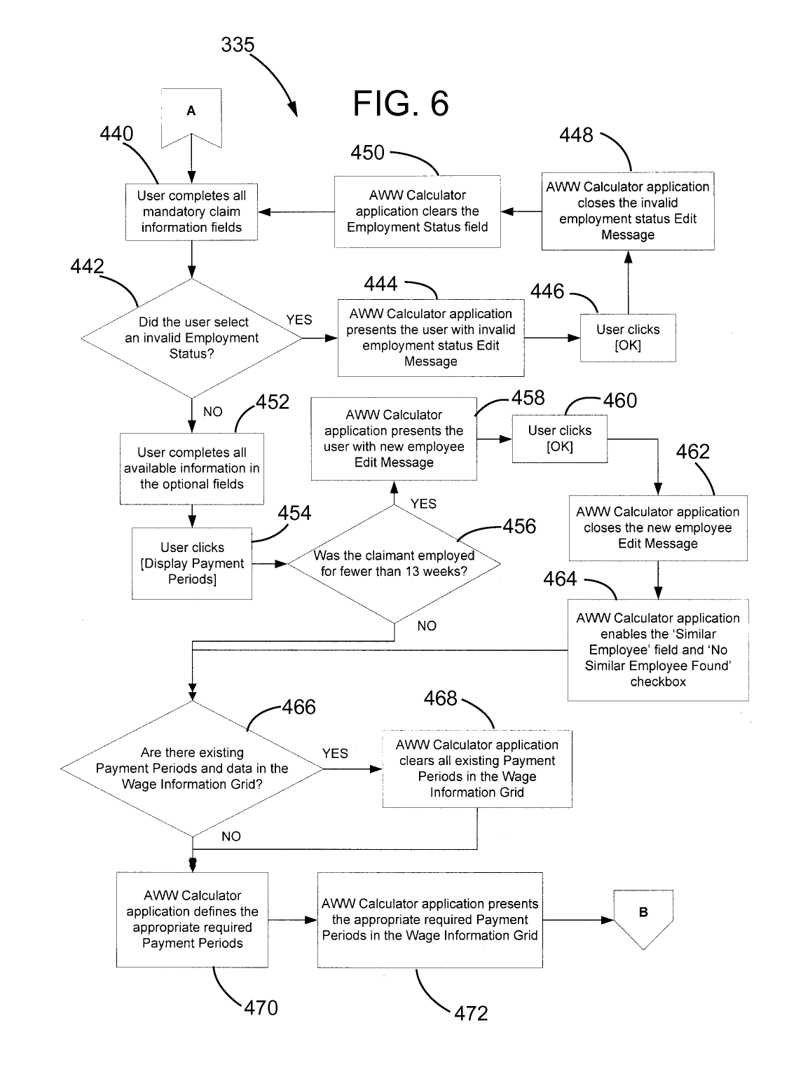

Referring to FIG. 6, an embodiment is shown of a method 335 for inputting claim information into an AWW Calculator application constructed in accordance with principles of the present disclosure to determine the required payment periods for computing the AWW. The AWW Calculator application is adapted to determine the required payment periods based on the available claim information.

After the user has launched the AWW Calculator, the user completes all mandatory claim information fields (step 440). In one illustrated embodiment, the claim number, the Benefit State, the Date of Injury, and the Claimant name are all mandatory fields that are pre-populated by the AWW Calculator application when it is launched. The Pay Cycle field, the Example of first day in Pay Cycle? field, the Employment Status field, the Employed for fewer than 13 weeks? field, and the Non-pecuniary wages suspended? field are all mandatory fields. The Can you split bi-weekly wages into weekly segments? field is configured to become a mandatory field if the Pay Cycle field has a value of “Bi-Weekly.”

If the user selects an invalid Employment Status (in some embodiments, examples of an Invalid Employment Status include: Part-Time (not regular), Seasonal, Apprentice, Minor, Student, and Trainee) (decisional step 442), the AWW Calculator application presents the user with an Invalid Employment Status Message, such as, “The AWW Calculator does not calculate the Average Weekly Wage of [invalid Employment Status selected] workers'. Please consult the applicable [Benefit State] Statute related to this Employment Status to ensure the AWW is calculated correctly” (step 444). The Invalid Employment Status Message can include an [OK] button/link. When the user clicks [OK] (step 446), the AWW Calculator application closes the Invalid Employment Status Message (step 448). The AWW Calculator application clears the Employment Status field (step 450).

The user completes all available information in the optional fields (step 452). In the illustrated embodiment, the AWW from FROI field is an optional field.

The user clicks the [Display Payment Periods] button/link (step 454) and, in response, the AWW Calculator application determines the appropriate required Payment Periods (step 470). If the user selects “Yes” for the Employed for fewer than 13 weeks? field (decisional step 456), the AWW Calculator application presents the user with a New Employee Message, such as, “If the employee was not employed for thirteen continuous weeks before the date of injury, report the wages of an employee who has training, experience, skills and wages comparable to the injured employee AND who performs services/tasks comparable in nature and in number of hours. If no similar employee exists, report the limited available wages earned by the injured employee prior to the injury” (step 458). The New Employee Message can include an [OK] button/link. When the user clicks [OK] (step 460), the AWW Calculator application closes the New Employee Message (step 462) and enables the Similar Employee field and No Similar Employee Found checkbox in the graphical user interface (step 464).

If there are existing Payment Periods and data in the Wage Information grid (decisional step 466), the AWW Calculator application clears all existing Payment Periods in the Wage Information grid (step 468). The AWW Calculator application presents the appropriate required Payment Periods in the Wage Information Grid, including the Start Date and End Date of all required Payment Periods (step 370).

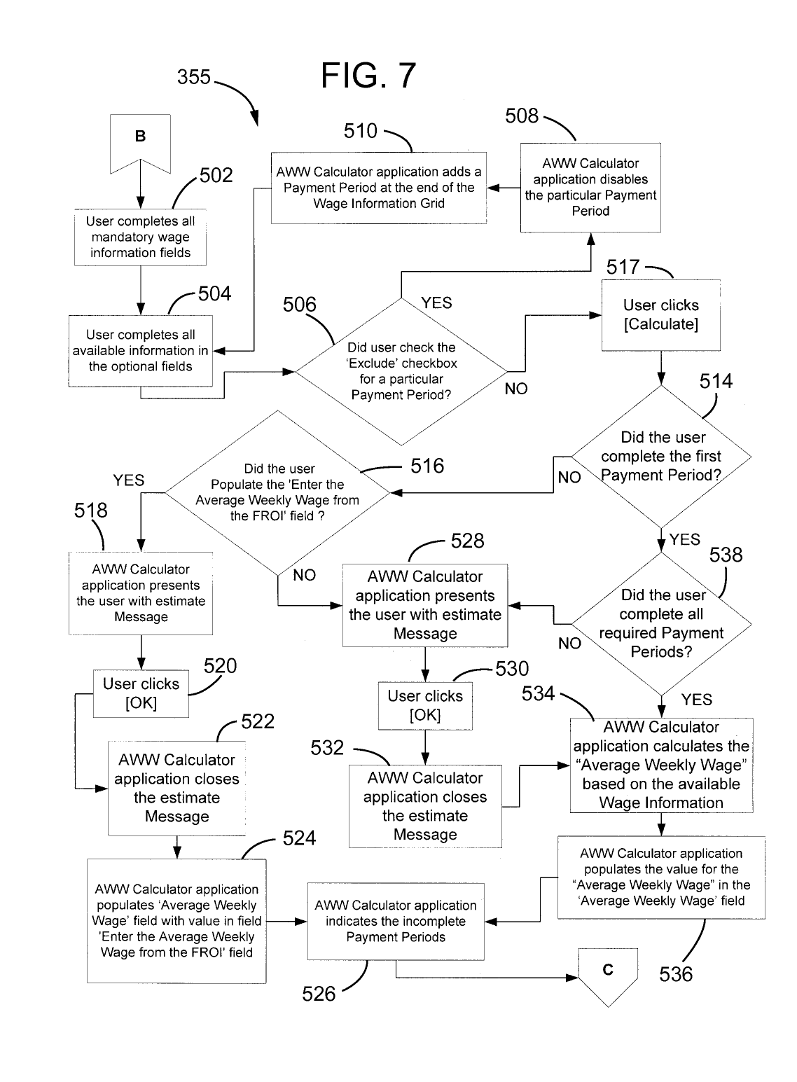

Referring to FIG. 7, an embodiment is shown of a method 355 for inputting wage information into an AWW Calculator application constructed in accordance with principles of the present disclosure and calculating the AWW based upon the entered wage information. After the user has completed the Claim Information and the AWW Calculator application has presented the required Payment Periods, the user completes all mandatory wage information fields (step 502).

In the illustrated embodiment, the Star Date and End Date of each required Payment Period are mandatory fields that are pre-populated by the AWW Calculator application when the required payment Periods are determined. The Gross Wages field is configured to become a mandatory field if the Non-pecuniary Wages field has a value. The Non-pecuniary Wages field is configured to become a mandatory field if the Non-pecuniary wages suspended? field has a value of “Yes” and the corresponding Gross Wages field has a value. The Similar Employee field is configured to become a mandatory field if the Employed for fewer than thirteen weeks? field has a value of “Yes” and the No Similar Employee Found field is blank. The No Similar Employee Found field is configured to become a mandatory field if the Employed for fewer than thirteen weeks? field has a value of “Yes” and the Similar Employee field is blank.

The user completes all available information in the optional fields (step 504). In the illustrated embodiment, the Exclude checkbox is optional.

If the user checks the Exclude checkbox for a particular Payment Period (decisional step 506), the AWW Calculator application disables the particular Payment Period (step 508). The AWW Calculator application adds a Payment Period at the end of the Wage Information grid (step 510).

When the user clicks [Calculate] (step 512), the AWW Calculator application calculates the Average Weekly Wage based on the available Wage Information (step 534). The system populates the value for the Average Weekly Wage in the Average Weekly Wage field of the graphical user interface. The AWW Calculator application indicates the incomplete Payment Periods (e.g. color code the rows in which the Payment Periods are incomplete) (step 526).

If the user has not completed the first Payment Period and the AWW From FROI field is populated when the user clicks the [Calculate] link/button (decisional steps 514, 516), the AWW Calculator application presents an Estimate Message, such as, “The following AWW calculation is considered an estimate as there is missing wage information” (step 518) The Estimate Message can include an [OK] button/link. When the user clicks [OK] (step 520), the AWW Calculator application closes the Estimate Message (step 522) and populates the Average Weekly Wage field with the value in the AWW from FROI field (step 524).

If the user has not completed the first Payment Period and the AWW From FROI field is not populated when the user clicks the [Calculate] link/button (decisional steps 514, 516), the AWW Calculator application presents the Estimate Message (step 528). When the user clicks [OK] (step 530), the AWW Calculator application closes the Estimate Message (step 532) and calculates the AWW based on the available information (step 534).

If the user has completed the first Payment Period but not all required Payment Periods when the user clicks the [Calculate] link/button (decisional steps 514, 538), the AWW Calculator application presents the user with the Estimate Message (step 528). When the user clicks [OK] (step 530), the AWW Calculator application closes the Estimate Message (step 532) and calculates the AWW based on the available information (step 534).

After calculating the AWW, the AWW Calculator application presents the user with the Average Weekly Wage. In the illustrated embodiment, the AWW becomes the value for the AWW field in the Wage Information section of the graphical user interface (step 536). The AWW Calculator application indicates the incomplete Payment Periods (e.g. color code the rows in which the Payment Periods are incomplete) (step 526).

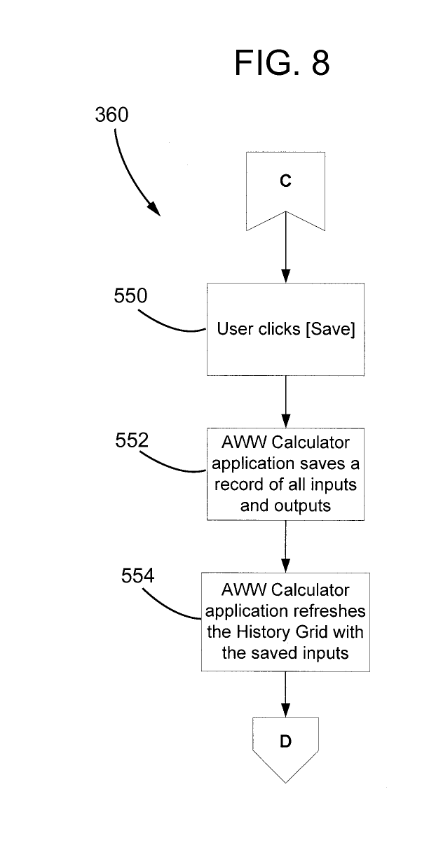

Referring to FIG. 8, an embodiment of a method 360 is shown for saving an AWW record using an AWW Calculator application constructed in accordance with principles of the present disclosure. The method can be used to save the inputs and outputs of the Average Weekly Wage calculation made by the AWW Calculator application.

After the user has initiated the [Calculate] function and the AWW Calculator application has calculated the Average Weekly Wage, the AWW Calculator application populates the AWW field with a value. When the user clicks the [Save] link/button in the Wage Information section of the graphical user interface (step 550), the AWW Calculator application saves a record of all inputs and outputs in a suitable database (step 552). The AWW Calculator application refreshes the History Grid with the saved inputs and/or populates a record on the History Information grid (step 554).

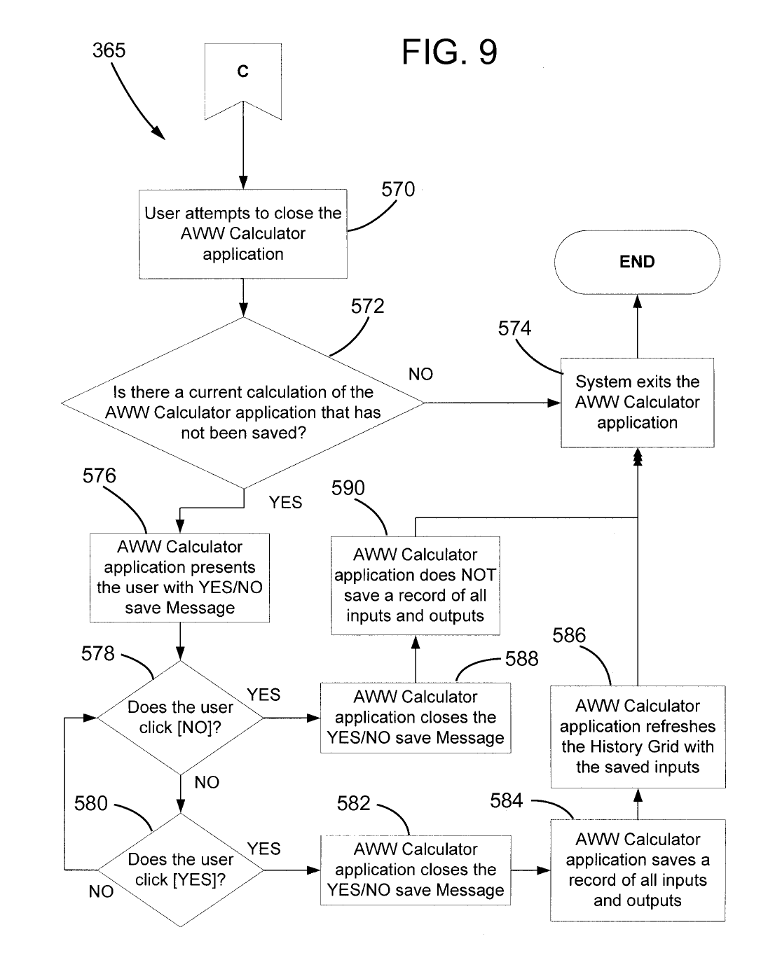

Referring to FIG. 9, an embodiment is shown of a method 365 for presenting a user with an option to save an AWW record before closing an AWW Calculator application constructed in accordance with principles of the present disclosure. If a user calculates an AWW, saves the record (decisional step 572), and then attempts to close the AWW Calculator (step 570), then the AWW Calculator application performs the [Close] function (step 574). The AWW Calculator application can be adapted to provide the user with the option of saving an existing AWW calculation if the user attempts to close the AWW Calculator without saving the current AWW calculation.

If the user has initiated the [Calculate] function without subsequently initiating the [Save] function (decisional step 572) and then attempts to close the AWW Calculator (i.e. the user clicks the [Close] function, presses ALT+F4, or right-clicks on the AWW Calculator and selects “Close,” for example) (step 570), the AWW Calculator application presents the user with a Yes/No Save Message, such as, “Would you like to save the current Average Weekly Wage calculation?” (step 576.) The Yes/No Save Message can include a [Yes] button/link and a [No] button/link.

If the user clicks [Yes] (decisional steps 578, 580), the AWW Calculator application closes the Yes/No Save Message (step 582) and saves an AWW record of all inputs and outputs (step 584). The AWW Calculator application refreshes the History grid with the saved AWW record (step 586). The AWW Calculator application exits the AWW Calculator (step 574).

If the user clicks [No] (decisional steps 578, 580), the AWW Calculator application closes the Yes/No Save Message (step 588). The AWW Calculator application does not save an AWW record of all inputs and outputs (step 590) and exits the AWW Calculator (step 574).

In various embodiments, an AWW Calculator calculating program in accordance with principles of the present disclosure can take the form of a computer program product on a tangible, computer-readable storage medium having computer-readable program code means embodied in the storage medium. The software implementations of the program for determining an Average Weekly Wage amount based upon claim information and wage information as described herein can be stored on any suitable tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, a tangible storage medium includes a distribution medium and art-recognized equivalents and successor media, in which the software implementations herein are stored.

The AWW Calculator application can be adapted to include a business process for the communication of updated laws and regulations to modify the calculation of the AWW to conform to the current rules of the jurisdiction(s) for which the application is to be used. This business process can be used to properly identify any required updates to the AWW Calculator.

The calculation of the Average Weekly Wage can vary according to the Employment Status based on the Benefit State populated in the Claim Information section of the AWW Calculator. The number of weeks required to accurately calculate the Average Weekly Wage can vary based on the Benefit State populated in the Claim Information section of the AWW Calculator. Additionally, extra columns can be added to the Wage Information Grid based on the Benefit State and Employment Status populated in the Claim Information section of the AWW Calculator. These additional columns may factor into the AWW calculation.

The AWW Calculator application can be adapted to pro-rate the Payment Period in which the Date of Injury occurred based on the Benefit State populated in the Claim Information section of the AWW Calculator. The AWW Calculator application can be adapted to calculate the Average Weekly Wage according to highest value of a consecutive number of Payment Periods based on the Benefit State populated in the Claim Information section of the AWW Calculator.

In yet other embodiments, the AWW Calculator application can be adapted to calculate the AWW using different formulas depending upon the number of days per year the claimant worked. For example, in instances where the Benefit State is New York, a tiered approach can be used depending upon whether the claimant worked over two hundred days in a year.

If the employee is not a seasonal employee and the “straight division” formula function is turned off, an AWW Calculator can include logic which is invoked to calculate the AWW as follows. If the total number of days worked per year is 200 or more, the AWW will be calculated as follows:

1) Determine average Daily Rate (DR) as Gross wages (GW) (total of all wages in the columns), divided by total number of days worked in a year (DW)

2) Determine Adjusted Gross Wage (AGW) as DR multiplied by a number which depends on the number of days worked (Multiplier). Multiplier is determined base on the days worked total per year:

If DW is 270 or more, the Multiplier is 300,

If DW is 234 to 269, the Multiplier is 260, and

If DW is 200 to 233, the Multiplier is 200.

3) Determine the Average Weekly Wage (AWW) which equals AGW/52, (approximately the number of weeks in a year)

4) Thus, AWW=AGW/52=(DR×Multiplier)/52=(GW/DW×Multiplier)/52. The resulting value is the final AWW to be presented on the calculator screen

If the employee worked one hundred ninety-nine days or less in the year, then the AWW Calculator can be adapted to use “Straight division” logic, regardless of the selection that the user makes for the “Straight Division” question. In other embodiments, the “Straight Division” field can be disabled when the number of days worked in the year is less than two hundred.

If the user selects “No” in answer to the “Straight Division” question, and provides a days worked value which is one hundred ninety-nine or less, the AWW Calculator can be adapted to apply “Straight Division” logic, display the AWW, display the formula used, and display a warning message in red, such as, “ ‘Straight Division’ was used due to insufficient number of days worked.” The message can be displayed on top of the formula, at the bottom of the Wages Information Section, after the calculated AWW value, the AWW Calculator displays the formula which resulted in the calculated value. Each number in the formula is qualified with a text explaining its meaning. For example, the display can read, “Total gross wages 52,000/365 calendar days=142.47 Daily rate*7=997.26 AWW.” In some embodiments, the formula is not be displayed if the AWW value is coming from a single value entered in the AWW from FROI field, rather than being a result of calculation.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computer-implemented system for processing a claimant's workers' compensation claim comprising:
a physical computer-readable medium including an average weekly wage calculating program; and
a processor adapted to execute the average weekly wage calculating program contained on the physical computer-readable medium;
wherein the average weekly wage calculating program includes a calculating module having computer executable instruction adapted to determine the average weekly wage based upon a predetermined formula using the claimant's wage information.

2. The system of claim 1, wherein the calculating module is adapted to determine the average weekly wage based upon claim information relating to at least one of the benefit state, the date of injury, the claimant's pay cycle, the claimant's employment status, and the duration of time the claimant had been employed on the date of injury.

3. The system of claim 1, wherein the average weekly wage calculating program includes a payment period module adapted to determine a required number of payment periods to use to calculate the average weekly wage.

4. The system of claim 3, wherein the payment period module is adapted to determine a pay cycle based upon information received in the average weekly wage calculating program relating to an example of a first day in the claimant's pay cycle.

5. The system of claim 3, wherein the calculating module is adapted to determine the average weekly wage based upon the total number of days in the required payment periods and the total wages relating to the total number of days.

6. The system of claim 5, wherein the calculating module is adapted to determine the average weekly wage based upon the quotient of the total number of days divided by the total wages.

7. The system of claim 6, wherein the calculating module is adapted to determine the average weekly wage as being equal to the total number of days/the total wages×7.

8. The system of claim 1, wherein the calculating module is adapted to determine the average weekly wage based upon an average daily rate.

9. The system of claim 8, wherein the calculating module is adapted to determine the average daily rate based upon the total number of days worked in a year and the total wages for those days worked.

10. The system of claim 9, wherein the calculating module is adapted to determine the average daily rate based upon an adjusted gross wage which is equal to the average daily rate multiplied by a predetermined multiplier.

11. The system of claim 10, wherein the multiplier is based upon the total number of days worked in a year.

12. A method for processing a claimant's workers' compensation claim comprising employing a processor to execute computer executable instructions stored on a tangible computer-readable medium to perform the steps of:
receive pre-defined claim information concerning a workers' compensation claim;
defining a set of payment periods required to calculate an average weekly wage based on the received claim information;
receiving wage information for the required payment periods; and
calculating the average weekly wage based on the received wage information.

13. The method of claim 12, wherein the claim information is received from an adjustor.

14. The method of claim 13, wherein the wage information is received from an adjustor based upon a wage statement.

15. The method of claim 12, wherein the average weekly wage is calculated based upon the total number of days in the required payment periods and the total wages relating to the total number of days.

16. The method of claim 15, wherein the average weekly wage is calculated based upon the quotient of the total number of days divided by the total wages.

17. The method of claim 16, wherein the average weekly wage is calculated as being equal to the total number of days/the total wages×7.

18. The method of claim 12, wherein the average weekly wage is calculated based upon an average daily rate.

19. The method of claim 18, wherein the average weekly wage is calculated based upon the total number of days worked in a year and the total wages for those days worked.

20. The method of claim 19, wherein the average daily rate is based upon an adjusted gross wage which is equal to the average daily rate multiplied by a predetermined multiplier.

21. The system of claim 20, wherein the multiplier is based upon the total number of days worked in a year.

23. A non-transitory, tangible computer-readable storage medium bearing instructions for calculating an average weekly wage for a claimant, the instructions, when executing on one or more computing devices, perform the step of:
receive pre-defined claim information concerning a workers' compensation claim;
defining a set of payment periods required to calculate an average weekly wage based on the received claim information;
receiving wage information for the required payment periods; and
calculating the average weekly wage based on the received wage information.
